(19) United States
(12) Patent Application Publication
(10) Pub. No.: US 2008/0239555 A1
(43) Pub. Date: Oct. 2, 2008

(54) Multi-quadrant wedge offset reduction field values for disk drive servo

(75) Inventors: Richard M. Ehrlich, Saratoga, CA (US); Thorsten Schmidt, Fremont, CA (US)

Correspondence Address: SCHWEGMAN, LUNDBERG & WOESSNER/TOSHIBA, P.O. BOX 2938, MINNEAPOLIS, MN, 55402, US

(73) Assignee: TOSHIBA AMERICA INFORMATION SYSTEMS, INC., IRVINE, CA (US)

(21) Appl. No.: 11/731,215

(22) Filed: Mar. 30, 2007

(51) Int. Cl. G11B 5/596

(52) U.S. Cl. 360/77.08; 360/135

(57) ABSTRACT

A method for servo correction includes determining a first wedge offset reduction field value for a read element from information in a servo burst area of a wedge on a disk, storing the first wedge offset reduction field value, determining a second wedge offset reduction field value for the read element from information in the servo burst area of the wedge on the disk, storing the second wedge offset reduction field value, and estimating an offset value of the read element from a desired track on the disk using at least one of the first wedge offset reduction value or second wedge offset reduction field value.

### TECHNICAL FIELD

A disk drive is an information storage device. A disk drive includes one or more disks clamped to a rotating spindle, and at least one head for reading information representing data from and/or writing data to the surfaces of each disk. More specifically, storing data includes writing information representing data to portions of tracks on a disk. Data retrieval includes reading the information representing data from the portion of the track on which the information representing data was stored. Disk drives also include an actuator utilizing linear or rotary motion for positioning transducing head(s) over selected data tracks on the disk(s). A rotary actuator couples a slider, on which a transducing head is attached or integrally formed, to a pivot point that allows the transducing head to sweep across a surface of a rotating disk. The rotary actuator is driven by a voice coil motor.

Disk drive information storage devices employ a control system for controlling the position of the transducing head during read operations, write operations and seeks. The control system includes a servo control system or servo loop. The function of the head positioning servo control system within the disk drive information storage device is two-fold: first, to position the read/write transducing head over a data track with sufficient accuracy to enable reading and writing of that track without error; and, second, to position the write element with sufficient accuracy not to encroach upon adjacent tracks to prevent data erosion from those tracks during writing operations to the track being followed, or to stop an ongoing write operation if continued writing might encroach upon an adjacent track.

A servo control system includes a written pattern on the surface of a disk called a servo pattern. The servo pattern is read by the transducing head. Reading the servo pattern results in positioning data or a servo signal used to determine the position of the transducing head with respect to a track on the disk. In one servo scheme, positioning data can be included in servo wedges, each including servo patterns. Information included in the servo patterns can be used to generate a position error signal (PES) that indicates the deviation of the transducing head from a desired track center. The PES is also used as feedback in the control system to provide a signal to the voice coil motor of the actuator to either maintain the position of the transducing head over a desired track centerline or to reposition the transducing head to a position over the centerline of a desired track.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2 is a partial detailed view of a disk from the disk drive shown in FIG. 1 that includes a servo pattern that includes servo bursts, according to an example embodiment.

FIG. 3 is a representation of another arrangement of servo bursts (null pattern) that could be used in a servo wedge, according to an example embodiment.

FIG. 4 is a schematic diagram of a disk drive and that includes an electrical schematic for determining the location of at least one servo burst edge in the servo wedge and producing a drive signal to the actuator driver of the disk drive, according to an example embodiment.

FIG. 5 is a discrete model of the disk drive system shown in FIGS. 1 and 4 and illustrates some of the principles and aspects of an example embodiment.

FIG. 6 is a flow chart of a method for determining the position of a track with respect to a read element, according to an example embodiment.

FIG. 7 is a flow chart of another method for determining the position of a track with respect to a read element, according to an example embodiment.

FIG. 8 is a representation of an ideal track with a head position as the transducer passes around the disk and the written in run-out at various positions around the disk, according to an example embodiment.

FIG. 9 is a flow diagram of a method for servo correction of a write head of a transducing head, according to an example embodiment.

FIG. 10 is a schematic of a disk from a disk drive system illustrating the placement of a first correction value and a second correction value with respect to a first burst edge and a second burst edge, according to an example embodiment.

The description set out herein illustrates the various embodiments of the invention and such description is not intended to be construed as limiting in any manner.

### DETAILED DESCRIPTION

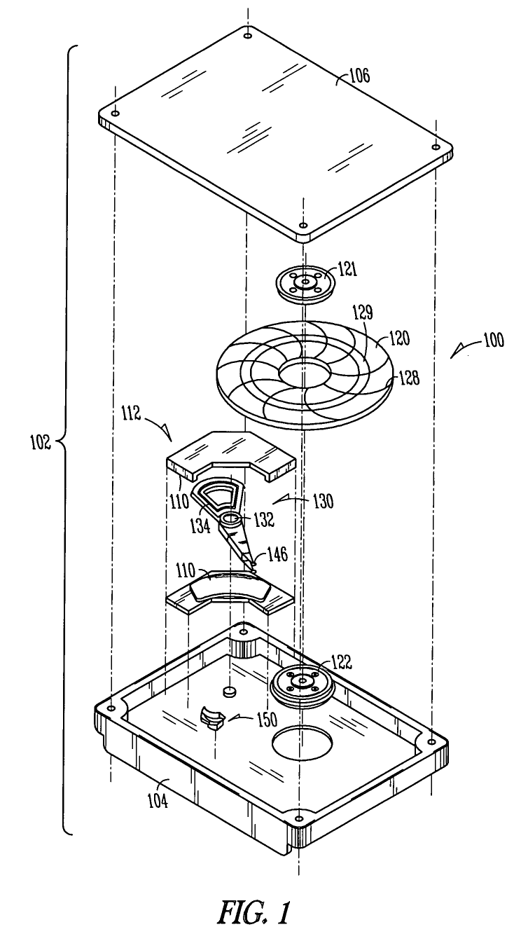

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

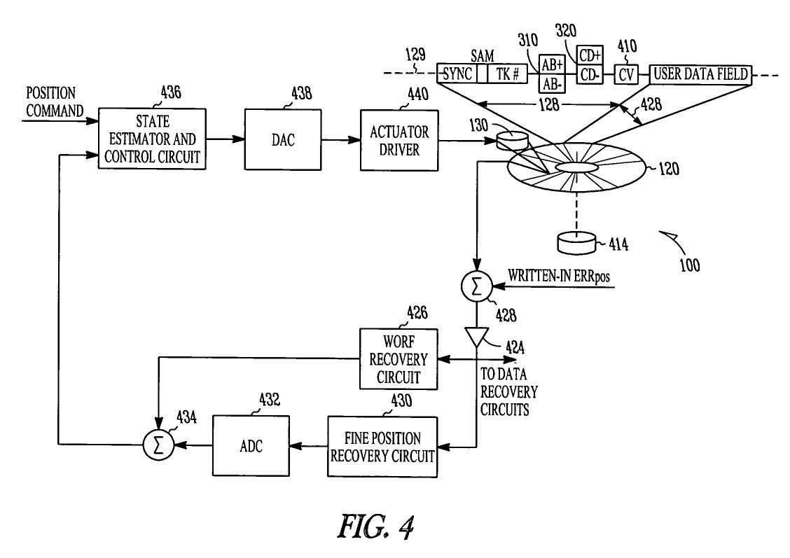

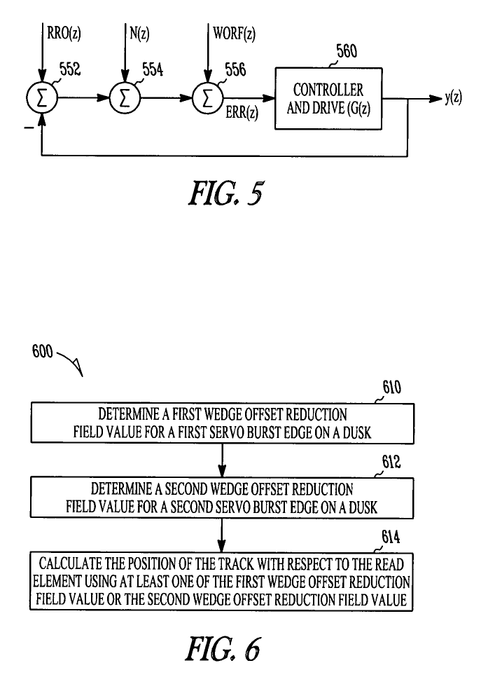

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132. The actuator accelerates in one angular direction when current is passed through the voice coil 134 and accelerates in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the transducing head 146 over one of a plurality of tracks on the disk 120. The servo system determines an appropriate current to drive through the voice coil 134, and drives the current through the voice coil 134 using a current driver and associated circuitry (shown in FIGS. 4 and 5). It should be noted that in some embodiments transducing includes two separate elements. One element is for reading information representing data and reading positional information or servo information. This element is known as a read element. The other element, in these embodiments, is for writing information representing data and is known as a write element. One example of such a transducing head is a magnetoresistive (MR) transducing head.

Each side of a disk 120 can have an associated head 146, and the heads 146 are collectively coupled to the rotary actuator 130 such that the heads 146 pivot in unison. The invention described herein is equally applicable to devices wherein the individual heads separately move some small distance relative to the actuator. This technology is referred to as dual-stage actuation (DSA).

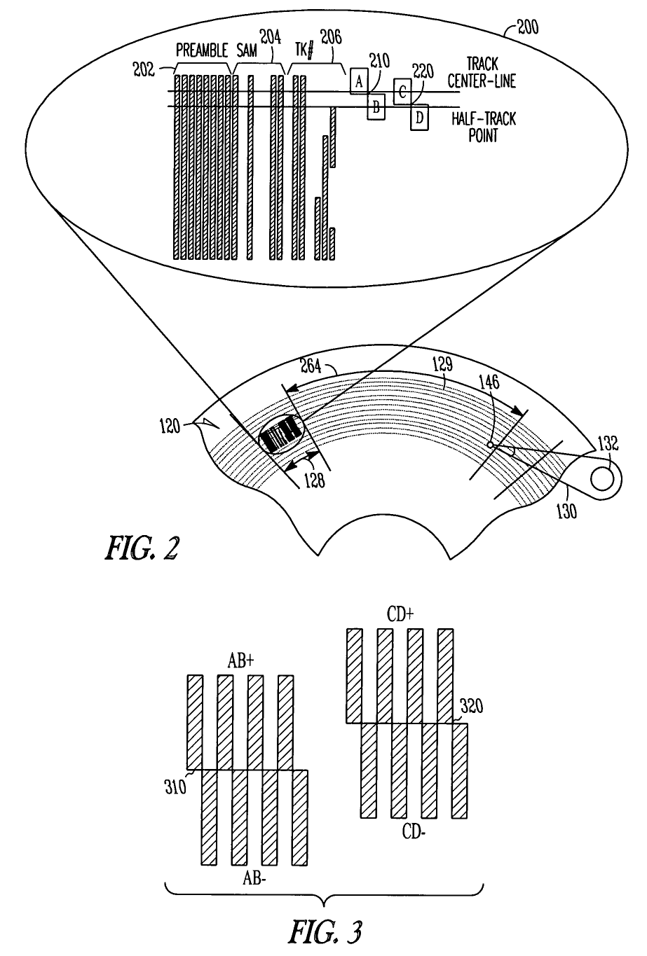

One type of servo system is an embedded, servo system in which tracks on each disk surface used to store information representing data contain small segments of servo information. The servo information, in some embodiments, is stored in radial servo sectors or servo wedges shown as several narrow, somewhat curved spokes 128 substantially equally spaced around the circumference of the disk 120. It should be noted that in actuality there may be many more servo wedges than as shown in FIG. 1. The servo wedges 128 are further detailed in FIGS. 2, 3 and 4 and in the discussions associated with those FIGs.

The disk 120 also includes a plurality of tracks on each disk surface. In FIG. 1, the plurality of tracks is depicted by multiple tracks, such as track 129, shown on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo sectors 128 are typically recorded with a servo writing apparatus at the factory (called a servo-writer), but may be written (or partially written) with the disk drive's 100 transducing head(s) 146 in a self-servowriting operation.

FIG. 2 shows a portion of a disk 120 having at least one servo wedge 128. Each servo wedge 128 includes information stored as regions of magnetization or other indicia, such as optical indicia. A servo wedge 128 can be longitudinally magnetized (for example, in the magnified portion of FIG. 2 a servo pattern 200 includes cross-hatched blocks magnetized to the left and white spaces magnetized to the right, or vice-versa) or alternatively perpendicularly magnetized (e.g., the cross-hatched blocks are magnetized out of the page and the white spaces are magnetized into the page, or vice-versa). Servo patterns 200 contained in each servo wedge 128 are read by the transducing head 146 as the surface of the spinning disk 120 passes under the transducing head 146. The servo patterns 200 can include information which can be used to identify a data sector contained in a data field 264. For example, the servo pattern 200 can include digital information such as a preamble 202, a servo address mark (SAM) 204, a track identification number 206. The servo pattern 200 also includes a set of servo bursts. As shown in FIG. 2, the set of servo bursts include an A servo burst, a B servo burst, a C servo burst, and a D servo burst. There is a servo burst edge 210 between the A burst and the B burst, and a servo burst edge 220 between the C burst and the D burst. The pattern shown is a quadrature type pattern. In some embodiments, a disk drive will include a single column of each type of servo burst in each servo wedge 128. Each column corresponds to a radial of the disk. In some embodiments, the servo wedge 128 will also include other information such as a wedge number. This can be a single bit to designate an index wedge (wedge #0), or the SAM may be replaced by another pattern (referred to as a servo index mark or SIM), or the wedge may contain a few low-order bits of the wedge number or a complete wedge number.

There are many different patterns for servo bursts. FIG. 3 shows another servo burst pattern which is associated with a null pattern. This pattern shows four servo bursts and it should be understood that this may also be repeated in columns so as to produce several radial lines of AB+, AB−, CD+ and CD− bursts on the disk in each servo wedge, such as servo wedge 128, on the disk. The servo burst pattern results in a servo burst edge 310 between the AB+ and AB− servo bursts, and a servo burst edge 320 between the CD+ and CD− servo bursts in the null pattern.

FIG. 4 is a schematic diagram of a disk drive 100 and that includes an electrical schematic for determining the location of at least one servo burst edge in the servo wedge 128 and producing a drive signal to the actuator driver of the disk drive, according to an example embodiment. As shown in FIG. 4, the disk 120 includes a servo wedge 128 that includes a null type servo burst pattern that includes the AB+, AB− burst edge 310 and the CD+, CD− burst edge 320. Also included in the servo wedge is a storage field for a correction value of the distance the AB+, AB− burst edge 310 is from the actual track and a correction value of the distance the CD+, CD− burst edge 320 is from the actual track. The correction values are also known as wedge offset reduction field (WORF) values. When a transducer includes one element that functions as both the read element and the write element, a WORF value is stored for the AB+, AB− burst edge 310 and the CD+, CD− burst edge 320. In the event that a transducer includes a separate read element and a separate write element, there can be a WORF value for the AB+, AB− burst edge 310 for both the read element and the write element, and a WORF value for the CD+, CD− burst edge 320 for both the read element and the write element. In some embodiments, a single WORF value for each AB+, AB− burst edge and a single WORF value for each CD+, CD− burst edge should be sufficient for both reading and writing, since the servo always uses the read element to determine the position of the read/write element, regardless of whether it is reading or writing. Of course, in some embodiments, the servo wedge may include a quadrature type servo pattern which will also have an AB burst edge 210 (shown in FIG. 2) and a CD burst edge 220 (shown in FIG. 2). The disk 120, which is one kind of media, includes a plurality of tracks 129 (shown also in FIG. 1), a data sector, and at least one wedge of servo information 128 written to the media. The tracks 129 pass through both the data sector and the at least one wedge of servo information 128. The wedge of servo information 128 includes a first servo burst edge 310, a second servo burst edge 320, and a first wedge offset reduction field value associated with the first burst edge written to the disk, and a second wedge offset reduction field value associated with the second burst edge written to the media.

The first wedge offset reduction field value and the second wedge offset reduction field value are stored on the disk 120 in the servo wedge 128 as depicted by the block 410 along track 129. The tracks pass through both the data sector and the at least one wedge of servo information 128. Although only one set of WORF values are discussed as being stored in the servo wedge 128, it should be noted that in some embodiments, a first wedge offset reduction field value and the second wedge offset reduction field value are determined for a plurality of tracks on disk. As mentioned above, in some embodiments, a third wedge offset reduction field value and a fourth wedge offset reduction field value are associated with the first burst edge 310 and the second burst edge 320, respectively. The servo burst edges 310, 320 can be associated with any number of burst patterns, such as a null servo pattern, or a quadrature servo pattern.

The actuator 130 is driven by an actuator driver 440. The actuator driver 440 delivers current to the voice coil motor (shown in FIG. 1). In operation, minute electrical signals induced from recorded magnetic flux transitions are amplified by a preamplifier 424 and then delivered to conventional disk drive data recovery circuits (not shown). The disk drive 100 includes a servo system 400 that is used to determine the location of a transducer. The servo system 400 is a feedback loop that measures the position of the transducing head and produces a drive current to input to the voice coil motor of the actuator to drive the transducing head to a position over a desired track. The servo system 400 includes a wedge offset reduction field (WORF) circuit 426 and a fine position recovery circuit 430. An actual location signal is determined by a transducing head and is summed with an error position signal and corrected with at least one of the WORF values associated with the AB burst 310 or the CD burst value 320. The signal is then used to produce a drive current at the actuator driver 440. Now turning to FIG. 4, the servo system will be discussed in more detail. The WORF circuit 426 recovers a digital burst correction value or WORF value from the WORF field 410 in the servo wedge 128 of the disk 120.

A summing node 428 is also included in a signal path downstream from the preamplifier 424 and denotes addition of an unknown position error component or repeatable runout (RRO) which was written into the servo wedge 428 during conventional servo writing operations at a laser-interferometer-based servo writer station. This position error RRO is added to relative amplitude values read from the fine position A, B, C and D servo bursts and recovered as a sum by a fine position recovery circuit 430, which may be a servo peak detector for recovering relative amplitudes of the e.g. A, B, C and D servo bursts as read by the transducing head. In other embodiments, the analog signal is digitized and a partial response maximum likelihood digital detector is used to determine the burst locations. These relative amplitudes (corrupted by the written-in position error RRO) are then quantized by an analog to digital converter 432 and supplied to a head position controller circuit 436. In the data stream from the converter 432, a summing node 434 combines a WORF value as read from the correction value field or WORF field 510 of the present servo sector 128 with the digitized position value in order to cancel out the position error RRO. As shown in FIG. 4, the correction value field or WORF field 510 stores the correction values or WORF values associated with both the AB burst edge and the CD burst edge. The controller circuit 436 receives head position command values from other circuitry within the disk drive 100 and combines the command values with the quantized and corrected head position values to produce a commanded actuator current value. This commanded current value calculated by node 436, converted into an analog value by a digital to analog converter 438, and applied to control an actuator driver circuit 440 which operates the rotary actuator 130 to adjust the position of the head relative to the data track 129 being followed.

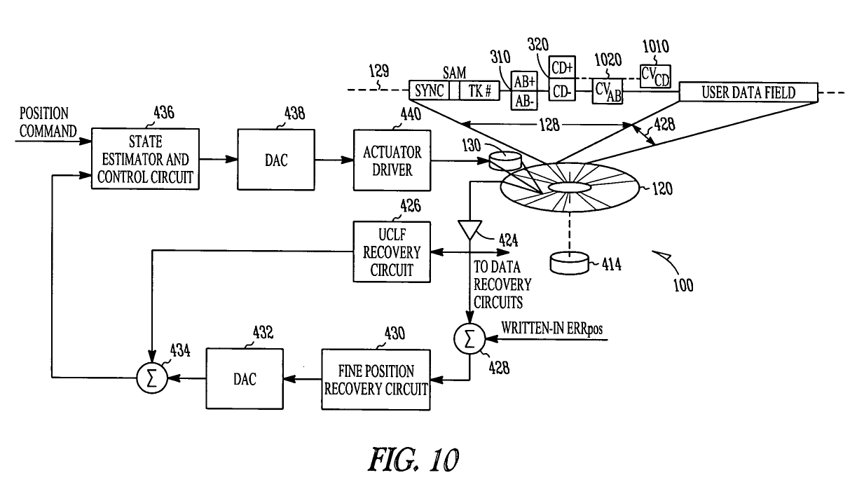

FIG. 10 is a schematic of a disk 120 from a disk drive system 1000 illustrating the placement of a first correction value and a second correction value with respect to a first burst edge and a second burst edge, according to another example embodiment. The disk drive system 1000 has many of the same elements as the disk drive system 100 shown in FIG. 4. Therefore, for the sake of brevity and simplicity, the main difference between the disk drive system 1000 and 100 will be discussed. In this particular embodiment, there is a first correction value field or WORF field 1010 associated with the AB burst edge 310 and a second correction value field or WORF field 1020 associated with the CD burst edge 320. The first correction value field or WORF value field 1010 is substantially aligned with the AB burst edge 310. The second correction value field or WORF value field 1020 is substantially aligned with the CD burst edge 320. In many instances, the burst edge relied on for correction will be the one the read head will be closest to so aligning the correction value field or WORF field 1010, 1020 with the associated burst edge 310, 320, respectively, will ease reading the correction value or WORF value. Even if both burst-edges are to be used, if the read head is close enough to a burst-edge that the corresponding burst-value(s) should be used in the PES determination, then associated WORF value should also be readable.

FIG. 5 is a discrete model of the disk drive system shown in FIGS. 1 and 4 and illustrates some of the principles and aspects of an example embodiment. In FIG. 5, the disk drive 100 including its on-board head position servo controller 436 and associated circuitry, is modeled as, but not limited to, a discrete time dynamic system G(z) included within block 550. In this exemplary model, let z represent the discrete-time time advance operator as is commonly used to transform continuous time systems to discrete time systems and let the Z-transform of the sampled time series rro(t) be represented as RRO(z). The dynamic system is subjected to an unknown repeated disturbance RRO(z) added at a summing node 552. Another unknown disturbance N(z), which is assumed zero mean noise, is added at a summing node 554 to the head position signal. Finally, a specified correction signal WORF(z) is added to the disturbed head position signal at a summing node 556. These three influences produce a combined influence ERR(z) which is the error term that drives the model 50. The resulting closed loop transfer function may be defined as:

ERR(z)=WORF(z)+N(z)+RRO(z)−G(z)·ERR(z)

which may be rearranged as:

WORF(z)+N(z)+RRO(z)=ERR(z)·[1+G(z)];

The RRO signal is, by definition, periodic. Being periodic, it is discrete in the frequency domain and can be represented as a finite length z-polynomial. Since it repeats every revolution of the disk spindle, it can be expressed as a summation of the various harmonics of the spindle. In fact, the only parts of rro(t) that exist are those that occur at ωᵢ, i=0 to M/2 where M is the number of servo position samples per revolution. Since G(z) is a linear system excited by a periodic signal rro(t), the only parts of G(z) of interest here are those at each ωᵢ. The whole system is treated as a summation of discrete systems, each operating at ωᵢ and solve each individually.

For a given ωᵢ, the calculation of WORF(jωᵢ) is straight forward, by measuring ERR(jωᵢ) (via discrete Fourier transform (DFT) or similar method), and knowing 1+G(jωᵢ), we calculate RRO(jωᵢ) from:

WORF(jωᵢ)+N(Jωᵢ)+RRO(jωᵢ)=ERR(jωᵢ)·[1+G(jωᵢ)];

The process of taking DFTs of err(t) at each ωᵢ and scaling each by the corresponding 1+G(jωᵢ) is the same as convolving err(t) with a kernel made from the response of 1+G(z) evaluated at each ωᵢ. Thus, we convolve the signal err(t) with the kernel to yield:

worf(t)+n(t)+rro(t)=err(t)\textcircled{x}kernel

where \textcircled{x} represents the convolution operator.

In accordance with principles and aspects of the present invention, the impact of the zero mean noise term, n(t) is minimized by synchronously averaging, or low pass filtering with an asymptotically decreasing time constant, either err(t), or err(t)−worf(t), for multiple revolutions of the spindle. The number of revolutions necessary is dependent upon the frequency content of the n(t) term. An n(t) having significant spectra near the spindle harmonics will require more revolutions of data filtering to sufficiently differentiate the spectra of rro(t) from n(t). In the presence of sufficient filtering, n(t) becomes small and the left side of the above equation reduces to:

worf(t)+rro(t)

which is the error between our calculated WORF values and the RRO values themselves. This format lends itself to an iterative solution:

worf(t)ₒ=O;

worf(t)ₖ₊₁=worf(t)ₖ+α·err(t)ₖ\textcircled{x}kernel;

where α is a constant near unity selected to yield a convergence rate that is forgiving to mismatches between the actual transfer function and that used to generate the kernel. It is also possible that the value of α could vary from iteration to iteration.

In accordance with principles and aspects of the present invention, the kernel is derived for each different disk drive product, by a process of either control system simulation or by injecting identification signals into the servo control loop and measuring responses to those signals. In some embodiments, a separate kernel can be determined for each manufactured drive, during the post-assembly manufacturing process steps. It is even possible to use a separately determine kernel for each head, or to even multiple kernels for each head, one for each of a multiple of radial zones on each head.

In one embodiment, two WORF values are used in demodulating a position error signal (PES). In one example embodiment, the method would associate one offset or WORF value with the placement-error of each of the two burst-edges, such as 210, 220, or 310, 320 (shown in FIGS. 1-4). The offset or WORF value would be added to the portion of the position error signal (PES) that was due to its corresponding burst-pair (or burst-difference). If only one of the two burst-edges was used to determine the raw PES at any time, then only one of the two offset or WORF values would be used. If a linear combination of values corresponding to the two burst-edges, such as 210, 220, or 310, 320 (shown in FIGS. 1-4), was used, then the same weighting of the two offset or WORF values would be added to the raw PES.

FIG. 6 is a flow chart of a method 600 for determining the position of a track with respect to a read element, according to an example embodiment. The method 600 for determining the position of a track with respect to a read element includes determining a first wedge offset reduction field value for a first servo burst edge on a disk 610, and determining a second wedge offset reduction field value for a second servo burst edge on a disk 612. The method 600 also can include calculating the position of the track with respect to the read element using at least one of the first wedge offset reduction field value or the second wedge offset reduction field value 614.

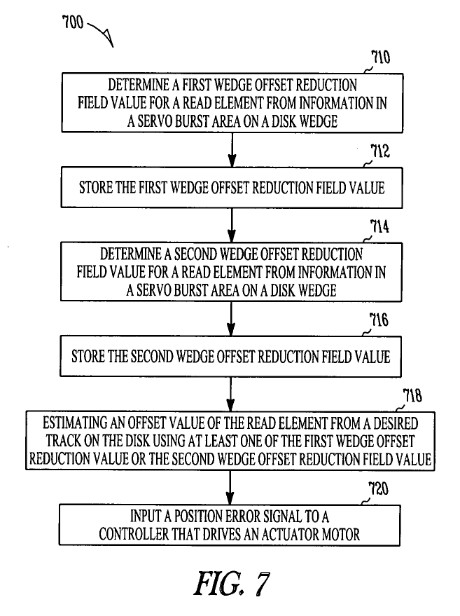

FIG. 7 is a flow chart of another method 700 for determining the position of a track with respect to a read element, according to an example embodiment. The method 700 for servo correction includes determining a first wedge offset reduction field value for a read element from information in a servo burst area of a wedge on a disk 710, storing the first wedge offset reduction field value 712, determining a second wedge offset reduction field value for the read element from information in the servo burst area of the wedge on the disk 714, storing the second wedge offset reduction field value 716, and estimating an offset value of the read element from a desired track on the disk using at least one of the first wedge offset reduction value or second wedge offset reduction field value 718. In some embodiments, the first wedge offset reduction field value and the second wedge offset reduction field value are stored on the disk. The method 700 can also include inputting a position error signal to a controller that drives an actuator motor 720. The position error signal is used by the controller to determine how it should move the read element so that it follows a selected or desired track. The position error signal is determined from the information from the servo wedge on the disk, and at least one of the first wedge offset reduction value or second wedge offset reduction field value. In one embodiment, the first wedge offset reduction field value for a read element is determined from a first burst edge in the servo burst area, such as 210, or 310 (shown in FIGS. 2-4). In still another embodiment, the first wedge offset reduction field value for a read element is determined from a first burst edge in the servo burst area, such as 210, or 310 (shown in FIGS. 2-4), and the second wedge offset reduction field value is determined from the second burst edge in a servo burst area, such as 220, or 320 (shown in FIGS. 2-4). In still another embodiment, estimating an offset value of the read element from a desired track on the disk 718 includes using both the first wedge offset reduction value and second wedge offset reduction field value.

The two WORF values for a particular element are determined during testing of the disk drive 100. The means for determining the two WORF values depends upon the PES scheme used by the servo during that determination. There are a number of ways to determine the WORF values for the AB burst edge 210, 310 (shown in FIGS. 2-4) and the CD burst edge 220, 320 (shown in FIGS. 2-4). In one embodiment, the burst edge for just the AB burst edge 210, 310 (shown in FIGS. 2-4) is used for the PES-determination at each wedge 128. It should be noted that there are a plurality of servo wedges, such as servo wedge 128, positioned on radial lines around the disk. For the sake of simplicity in the explanation below, it will be assumed here that the AB edge 210, 310 is the one that is used for every servo wedge on a particular track 129 (see FIGS. 1-4). It should be noted that in other embodiments, the CD edge 212, 312 could also be used for each servo wedge on a particular track and also, in still another embodiment, the CD edges for some servo wedges could be used and the AB edge could be used for other servo wedges. In the embodiment where some servo wedges use the AB edge and other of the servo wedges use the CD edge for a particular track, it is important that, during the determination of the WORF values for a specific track, the same burst edges are used for any given servo wedge for each revolution of the disk. That is, if the AB burst-edge is used to determine the PES for wedge #0, but the CD edge is used for wedge #1 during the WORF determination step on a given track, the AB burst-edge would be used on wedge#0 for all revolutions of the measurement of RRO on that track, and the CD burst-edge would be used on wedge #1. Now, returning to the assumption that only the AB burst edges are used, the raw PES as determined using only the AB edge will be referred to below as PES_{AB}, and the raw PES as it would be determined using only the CD edge will be referred to as PES_{CD}. The WORF value corresponding to the AB edge would be determined by a circular convolution of the synchronously-averaged values of PES_{AB} and the inverse-discrete Fourier transform (DFT) of the inverse-sensitivity-function of the servo loop. In other words,

$${WORF}_{AB} ( n ) = {\sum }_{k = 0}^{N - 1} \overline{{PES}_{AB} ( k )} * {h}_{invsf} [ ( n - k ) \% N ]$$

where

P̅E̅S̅_̅{̅A̅B̅}̅(̅k̅)̅ is the synchronously-averaged value of PES_{AB} at wedge #k,

h_{invsf}(k) is the k'th value of the inverse-DFT of the inverse of the sensitivity-function of the servo-loop,

N is the number of wedges per revolution of the disk, and the “%” denotes the modulo function.

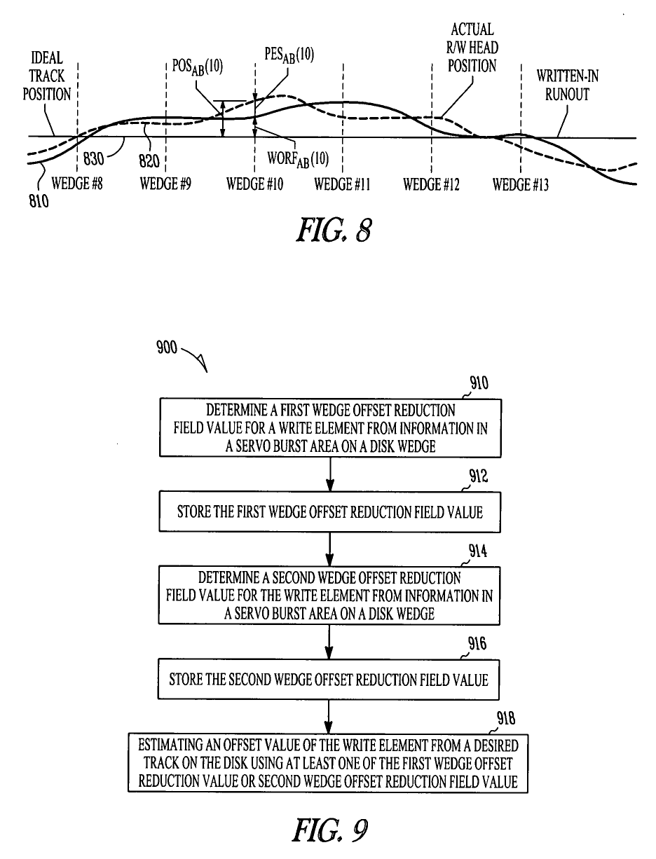

FIG. 8 is a representation of an ideal track with a head position as the transducer passes around the disk and the written in run-out at various positions around the disk, according to an example embodiment. In FIG. 8, the ideal track is shown as a line although in actuality, the ideal track is arcuate. As shown, the ideal track is a section of the disk that travels through servo wedges 8-13. As noted above, there may be many servo wedges, such as servo wedge 128, around the disk 120. In some disk drives there may be as many as 150 or more servo wedges. Therefore, the section of track 129 shown in FIG. 8 may also be such a short arcuate path that it may actually appear to be a line. FIG. 8 shows the misplacement of the AB edge for servo wedges #8 through #13 on a fictitious track 810 and the actual misplacement of the R/W head during a single revolution of the disk 820. The sensed raw PES from the AB-edge is simply the difference between the actual position of the read or write head and the misplacement of that edge. The convolution operation, defined above, accounts for the way in which the servo attempts to follow the written-in runout, resulting in a PES_{AB} that is different from the actual written-in runout. In this figure, the written-in runout at wedge #10 is labeled WORF_{AB}(10), implying that the determined WORF_{AB} value is perfectly correct. In actuality, the WORF_{AB} value for each wedge is only an estimate of the written-in runout of the AB-edge of that wedge.

Given this determination of the WORF_{AB} value for each wedge, the “best guess” of the actual position of the read or write head during the measurement (based upon observation of the AB edges alone) is:

POS_{AB}(n)= P̅E̅S̅_̅{̅A̅B̅}̅(̅n̅)̅+WORF_{AB}(n)

Where POS_{AB}(n) is the estimated mean actual position of the R/W head, relative to its ideal position 830, at wedge #n.
From the above two equations, an estimate of the appropriate values for WORF_{CD}(n) would be:

$$\begin{matrix}{WORF}_{CD} ( n ) = {POS}_{AB} ( n ) - \overline{{PES}_{CD} ( n )} \\ = \overline{{PES}_{AB} ( n )} + {WORF}_{AB} ( n ) - \overline{{PES}_{CD} ( n )}\end{matrix}$$

Here, P̅E̅S̅_̅{̅C̅D̅}̅(̅n̅)̅ refers to the synchronously-averaged value of PES_{CD} at the n'th wedge.

Some disk drives include transducers that have a separate read element and a separate write element. The method can then include determining a third wedge offset reduction field value for a write element from information in a servo burst area of a wedge on a disk, determining a fourth wedge offset reduction field value for the write element from information in the servo burst area of the wedge on the disk, and storing both the third and the fourth wedge offset reduction field value. An offset value of the write element from a desired track on the disk is estimated using at least one of the third wedge offset reduction value or the fourth wedge offset reduction field value. Estimating an offset value of the write element from a desired track on the disk can, in some embodiments, include using both the third wedge offset reduction value and fourth wedge offset reduction field value.

FIG. 9 is a flow diagram of a method 900 for servo correction of a write head of a transducing head, according to an example embodiment. The method 900 for servo correction includes determining a first wedge offset reduction field value for a write element from information in a servo burst area of a wedge on a disk 910, storing the first wedge offset reduction field value 912, determining a second wedge offset reduction field value for the write element from information in the servo burst area of the wedge on the disk 914, storing the second wedge offset reduction field value 916, and estimating an offset value of the write element from a desired track on the disk using at least one of the first wedge offset reduction value or second wedge offset reduction field value 918. In some embodiments, the first wedge offset reduction field and the second wedge offset reduction field value are stored on the disk. In some embodiments, estimating an offset value of the write element from a desired track on the disk 918 includes using both the first wedge offset reduction value and second wedge offset reduction field value. It is also possible, when using only first and second WORF values, to use them to correct for the head position during writing operations only (as opposed to using first and second WORF values to correct for the head position during reading operations).

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for servo correction comprising:
determining a first wedge offset reduction field value for a read element from information in a servo burst area of a wedge on a disk;
storing the first wedge offset reduction field value;
determining a second wedge offset reduction field value for the read element from information in the servo burst area of the wedge on the disk; and
storing the second wedge offset reduction field value.

2. The method of claim 1 wherein storing the first wedge offset reduction field value includes storing the first wedge offset reduction field value on the disk.

3. The method of claim 2 wherein storing the second wedge offset reduction field value includes storing the second wedge offset reduction field value on the disk.

4. The method of claim 1 further comprising inputting a position error signal to a controller that drives an actuator motor used to move the read element, the position error signal determined from the information from the servo wedge on the disk, and at least one of the first wedge offset reduction value or second wedge offset reduction field value.

5. The method of claim 1 wherein determining a first wedge offset reduction field value for a read element from information in a servo burst area of a wedge on a disk is determined from a first burst edge in the servo burst area.

6. The method of claim 5 wherein determining a second wedge offset reduction field value for the read element from information in the servo burst area of the wedge on the disk is determined from the second burst edge in a servo burst area.

7. The method of claim 1 further comprising estimating an offset value of the read element from a desired track on the disk using at least one of the first wedge offset reduction value or second wedge offset reduction field value

8. The method of claim 7 wherein estimating an offset value of the read element from a desired track on the disk includes using both the first wedge offset reduction value and second wedge offset reduction field value.

9. The method of claim 1 further comprising
determining a third wedge offset reduction field value for a write element from information in a servo burst area of a wedge on a disk;
storing the third wedge offset reduction field value;
determining a fourth wedge offset reduction field value for the write element from information in the servo burst area of the wedge on the disk; and
storing the fourth wedge offset reduction field value.

10. The method of claim 9 further comprising estimating an offset value of the write element from a desired track on the disk using at least one of the third wedge offset reduction value or the fourth wedge offset reduction field value.

11. The method of claim 10 wherein estimating an offset value of the write element from a desired track on the disk includes using both the third wedge offset reduction value and fourth wedge offset reduction field value.

12. A method for servo correction comprising:
determining a first wedge offset reduction field value for a write element from information in a servo burst area of a wedge on a disk;
storing the first wedge offset reduction field value;
determining a second wedge offset reduction field value for the write element from information in the servo burst area of the wedge on the disk; and
storing the second wedge offset reduction field value.

13. The method of claim 12 wherein storing the first wedge offset reduction field value includes storing the first wedge offset reduction field value on the disk.

14. The method of claim 13 wherein storing the second wedge offset reduction field value includes storing the second wedge offset reduction field value on the disk.

15. The method of claim 12 further comprising estimating an offset value of the write element from a desired track on the disk using at least one of the first wedge offset reduction value or second wedge offset reduction field value.

16. The method of claim 15 wherein estimating an offset value of the read element from a desired track on the disk includes using both the first wedge offset reduction value and second wedge offset reduction field value.

17. A media comprising:
a plurality of tracks;
a data sector; and
at least one wedge of servo information written to the media, the wedge of servo information including:
a first servo burst edge;
a second servo burst edge; and
a first wedge offset reduction field value associated with the first burst edge written to the disk; and
a second wedge offset reduction field value associated with the second burst edge written to the media, the tracks passing through both the data sector and the at least one wedge of servo information.

18. The media of claim 17 wherein the first wedge offset reduction field value and the second wedge offset reduction field value are written within the at least one wedge of servo information on the disk.

19. The media of claim 17 wherein first wedge offset reduction field values and second wedge offset reduction field values are determined for a plurality of tracks on disk

20. The media of claim 19 further comprising a third wedge offset reduction field value and a fourth wedge offset reduction field value associated with the first burst edge and the second burst edge, respectively.
